(19) United States
(12) Patent Application Publication
(10) Pub. No.: US 2026/0349956 A1
(43) Pub. Date: Nov. 5, 2026

(54) MULTICORE PROCESSOR AND METHOD FOR OPERATING A MULTICORE PROCESSOR IN AN AIRCRAFT

(71) Applicant: Liebherr-Aerospace Lindenberg GmbH, Lindenberg (DE)

(72) Inventors: Laurent DIEUDONNÉ, Lingenau (AT); Thomas DEDLER, Lindenberg (DE)

(21) Appl. No.: 19/555,262

(22) Filed: Mar. 3, 2026

(30) Foreign Application Priority Data
Mar. 6, 2025 (DE) 10 2025 108 497.1

(51) Int. Cl. G06F 15/80; G06F 9/54

(52) U.S. Cl. CPC G06F 15/80; G06F 9/541

(57) ABSTRACT

The disclosure relates to a multicore processor, comprising at least one first processor core for performing computing operations, also called an application core, and at least one second processor core for performing computing operations, also called a proxy core. The at least one application core and the at least one proxy core both have, from the perspective of the hardware architecture, access to processor and/or hardware resources. The at least one application core and the at least one proxy core are each provided with a platform software that is designed to ensure that the resources actually accessible by at least the two processor cores are accessible only by exactly one proxy core, wherein the platform software is provided if a deterministic behavior of the addressed resource is not guaranteed or evident in hardware when accessed concurrently by the processor cores.

### CROSS REFERENCE TO RELATED APPLICATION

The present application claims priority to German Patent Application No. 10 2025 108 497.1 filed on Mar. 6, 2025. The entire contents of the above-listed application are hereby incorporated by reference for all purposes.

### TECHNICAL FIELD

The present disclosure relates to a multicore processor and a method for operating a multicore processor in an aircraft.

### BACKGROUND

In modern aerospace technology, control components play a central role, as they form the basis for the safe and efficient control of aircraft. These components make it possible to precisely control complex systems and thus ensure the functionality and reliability of the aircraft. With the continuous increase in performance requirements and the complexity of flight control systems, the need for powerful and reliable processor solutions is also growing. Multicore processors have established themselves as a key technology in this regard, as they allow the parallel execution of multiple software applications and thus offer higher computing performance.

### SUMMARY

The use of multicore processors in safety-critical applications such as aviation presents a particular challenge. In particular, the execution of software programs on these processors must occur in a functionally and temporally deterministic manner in order to meet the strict requirements of aviation standards (e.g., DO-178C and AMC 20-193). Moreover, the property of “robust partitioning” is essential to ensure a clear separation and non-interference of the individual software partitions, as defined, for example, in the standard AMC 20-193.

So far, high-performance platforms in aerospace that could execute multiple software applications in parallel were based on powerful single-core processors. With increasing performance requirements, multiple single-core processors were used in parallel on the same board or on separate computers, which led to limited communication performance and rising complexity. The communication performance between processors was often inadequate, and the implementation became increasingly complicated due to the growing number of processors.

The introduction of multicore processors (i.e., multi-core processors) does offer a solution for the increased performance demands, but it brings new challenges. Traditional methods such as Asymmetric Multi-Processing (AMP), Symmetric Multi-Processing (SMP), and hypervisor-based virtualization are not optimally suited in their current form for use in safety-critical aviation systems. These methods have disadvantages ranging from lack of synchronization between the software partitions, difficulties in ensuring functional and temporal determinism, to complex validation processes.

While the AMP approach does allow independent execution of software on individual cores, it lacks native coordination between the software partitions on different cores. This can lead to data inconsistencies and unplanned wait times, impairing functional and temporal determinism. The SMP approach, on the other hand, requires SMP-capable operating systems that generally only work on identical cores and therefore are not suitable for heterogeneous multicore processors. Moreover, creating and validating a cross-core scheduling plan poses a major challenge.

Hypervisor-based virtualization provides a separation of resources through virtual hardware resources, but leads to unpredictable wait times due to unplanned access sequences to the real hardware resources. This makes it difficult to guarantee real-time responses of the software partitions and impairs the performance of the multicore processor.

Against this background, there is an urgent need for a new method of operating multicore processors in aviation systems that overcomes the aforementioned disadvantages. The present disclosure aims to provide a suitable method for operating a multicore processor, in particular the Texas Instruments Jacinto-7 (J7), that enables the execution of software programs in a functionally and temporally deterministic way in accordance with aviation standards DO-178C and AMC 20-193. By introducing mechanisms to avoid or reduce access conflicts on shared processor resources, functional and temporal determinism should be ensured and made provably demonstrable in a simple manner.

The disclosure thus contributes significantly to the property of “robust partitioning” for multicore processor-based products and represents an innovative solution for the realization of high-performance, safe, and certifiable flight control systems. It enables the use of modern multicore processors in safety-critical aviation applications and opens up new possibilities for the development of future aircraft control systems with increased performance requirements. “Robust partitioning” refers to the ability of a system to run different software partitions or applications on the same multicore processor such that they cannot influence each other. This concerns both the spatial and the temporal isolation of the partitions. Software partitions include applications and function like containers in which they are protected from external disturbances and themselves must not cause disturbances outside the partition. This isolation can only be achieved with a suitably appropriate underlying system (processor+platform software).

Through the challenges addressed, the disclosure contributes to the further development of aviation technology and to increasing the safety and efficiency of modern aircraft. It represents an important step toward the integration of advanced processor architectures into safety-critical systems and paves the way for innovative applications in aircraft control and beyond.

To overcome the disadvantages listed above, a multicore processor with the features described herein is provided.

This is achieved by a multicore processor, for example for operating a control component of an aircraft, that comprises at least one first processor core for performing computing operations, also called an application core, and at least one second processor core for performing computing operations, also called a proxy core, wherein the application core and the proxy core both have, from the perspective of the hardware architecture, access to processor and/or hardware resources, for example at least one input/output interface and/or at least one internal hardware component, wherein the application core and the proxy core are each provided with a platform software designed to ensure that the resources actually accessible by at least both processor cores are accessible only by exactly one proxy core, and wherein the platform software is provided if a deterministic behavior of the addressed resource is not guaranteed or evident in hardware when the processor cores access concurrently.

Through this specific architecture, the potentially conflict-prone resource accesses by the software applications running on the different cores (for example the application cores) are either avoided or reduced such that they are predictable and limited. As a result, the resulting timing interferences for the respective software applications are bounded and predictable, i.e., temporally determinable.

The potentially conflict-prone resource accesses in a multicore processor are usually accesses to input/output interface components and internal hardware components, where a concurrent access by different processor cores can lead to non-deterministic behavior.

The basic concept of the present disclosure (and of the platform software) is based on the fact that shared hardware resources, where determinism is not guaranteed by the hardware for concurrent accesses or is not easily provable, are used by only a single core (the so-called proxy core).

This ensures that concurrent accesses to one and the same normally shared hardware resource no longer occur, so that the associated problems such as lack of determinism or the like are overcome.

This is achieved by specializing the processor cores for specific roles and tasks, whereby the assignment of resources allows each processor core either a common deterministic use or an exclusive use of the allocated resources.

According to an advantageous embodiment of the present disclosure, it can be provided that the multicore processor includes a memory configured for access by the application core and the proxy core, an input/output interface and/or an internal hardware component for inputting or outputting data which—on the basis of the hardware architecture of the multicore processor—is accessible by the application core and the proxy core, and a communication bus for connecting the application core, the proxy core, the memory, and the input/output interface and/or the internal hardware component. In this embodiment, the application core is configured, by virtue of the platform software, to refrain from a direct access by the application core to the input/output interface and/or the internal hardware component and to route data directed thereto to the memory, and the proxy core is configured, by virtue of the platform software, to take up the data originating from the application core from the memory and forward it to the input/output interface and/or the internal hardware component, optionally with static dedicated areas of the memory being assigned to the proxy core and/or the application core for data exchange between the processor cores.

The access to the hardware component is thus carried out exclusively by the proxy core, which forwards data originating from the application core to the component in such a way that simultaneous access is prevented and determinism can be ensured. The introduction of the proxy core to receive accesses originating from an application core, as well as the fact that exactly one proxy core is in exclusive connection with the hardware resource, leads to overcoming or mitigating the problems of the prior art.

Moreover, it can be provided that the memory is divided into dedicated areas that are used either by the proxy core or by the application core. Thus, it cannot happen that the proxy core and the application core access the same memory area simultaneously for read and/or write.

According to an optional modification of the present disclosure, it can be provided that the multicore processor is a heterogeneous multicore processor, in which in particular the application core and the proxy core form heterogeneous processor cores relative to each other.

Unlike a homogeneous multicore processor, in which all cores are identical in terms of architecture, performance, and functionality, a heterogeneous multicore processor consists of cores that differ in their architecture, performance, or functionality. The cores can support different instruction sets, have varying clock frequencies, or be optimized for specific tasks. Heterogeneous processors often combine high-performance cores with energy-efficient cores or specialized cores for specific computations such as graphics processing or artificial intelligence.

According to a further optional development of the present disclosure, it can be provided that a resource that is commonly usable from the perspective of the hardware architecture is used by only a single processor core—either the application core or the proxy core—when a concurrent access by more than one processor core does not guarantee a deterministic behavior or when such behavior is not provable.

According to an optional development of the present disclosure, it can further be provided that the at least one application core and the at least one proxy core perform certain functions and tasks such that the assignment of the commonly usable (from the hardware perspective) resource is carried out in such a way that each processor core can have either a common deterministic use or an exclusive use of the assigned resource. This also applies in the case when simultaneous accesses to a resource are addressed, since these can be temporally decoupled by the exclusive access of the upstream proxy core to the resource.

Furthermore, according to an optional refinement of the present disclosure, it can be provided that access rights of processor cores for the resource commonly usable from the hardware architecture perspective—or even additional processor cores of the multicore processor itself—are deactivated, for example statically deactivated, especially if a resource that is shared across multiple processor cores cannot be used deterministically and cannot be exclusively assigned to one processor core.

The hardware resources of a multicore processor are thus examined to determine whether, from a hardware perspective, access by multiple processor cores to a given hardware resource is possible. If so, then simultaneous access by multiple processor cores to these hardware resources must be prevented by restricting the access rights such that only exactly one processor core can access the respective hardware resource. This also covers the case that entire processor cores of the multicore processor are deactivated to ensure that only one processor core has exclusive access to a hardware resource which, from the hardware perspective of the multicore processor, could in principle be accessed by multiple processor cores. The processor core which then still has exclusive access to this hardware resource, and regulates access to this resource for other processor cores (i.e., acts as an intermediary), is called a proxy core.

Under certain circumstances it may be necessary that access rights of processor cores for a resource—or even the processor cores themselves—have to be deactivated if a shared resource cannot be used deterministically for the required scope and cannot be exclusively allocated to one processor core.

According to a further optional modification of the present disclosure, it can be provided that a processor core to which a resource is exclusively assigned provides indirect access to the exclusively assigned resource to another or all other processor cores while ensuring deterministic access to this resource. Usually, such a processor core is referred to as a proxy core, meaning it lies in the communication line between an application core and the hardware resource requested by the application core (e.g., an I/O port) which only the proxy core can access exclusively. If data addressed to the hardware resource arrive at the intermediary proxy core, it can resolve any concurrent accesses to the hardware resource that occur and thus prevent non-deterministic behavior.

According to a further optional modification of the present disclosure, it can be provided that the input/output interface comprises all types of binary signals, all types of static or dynamic signals from analog/digital and digital/analog converters, all types of signals from all kinds of communication controllers (whether requiring a specific protocol or not), and/or all types of signals from memory devices that require asynchronous management; and/or that the internal hardware component comprises passive components, such as slaves, or active components, such as bus masters. Optionally, the slaves are registers of processor features (such as timers/counters) or configuration registers, or working memory for program instructions and program data; and/or the bus masters are so-called engines that relieve a processor core from intensive activities like data transfer, complex calculations, propagation of processor events (in particular DMAs, checksum engines, or controllers).

According to a further optional refinement of the present disclosure, it can be provided that at least one proxy core is provided which assumes the role of a server and is designed to execute (at least in part, and optionally exclusively) the platform software that takes over direct access to now non-shared resources and implements the synchronization of accesses to these. In a typical application, the platform software is distributed across all proxy cores as well as multiple application cores, with all parts of the platform software working together to ensure the characteristics of safety and determinism.

The part of the platform software on at least one of the proxy cores serves to implement the exclusive access of the proxy core to the hardware resource managed by that proxy core. For this purpose, the part of the platform software is run on the proxy core which has the sole purpose of making the hardware resource exclusively managed by the proxy core accessible to other processor cores while ensuring deterministic function and/or deterministic behavior.

According to a further optional modification of the present disclosure, it can be provided that at least one application core is provided which is designed to execute at least one software application that communicates with the now non-shared resources only indirectly, by sending or receiving data via the proxy core to the desired resource, optionally using for this purpose the functions of the platform software of the proxy core.

The at least one software application can be any program that sends data via the proxy core to the resource (exclusively managed by the proxy core) or receives data from it.

According to a further refinement of the present disclosure, it can be provided that the platform software provides a software-based mechanism for deterministic communication between the at least one application core (in particular a software application running thereon) and the at least one proxy core (in particular platform software running thereon). Optionally, the mechanism is based on a dedicated memory component that has sufficient bandwidth and multiple interfaces to process competing accesses from multiple processor cores in a deterministic manner.

According to a further optional refinement of the present disclosure, it can be provided that at least one proxy core is provided which is designed to receive data addressed to non-shared hardware resources from other processor cores, in particular from another application core, and to transmit these data directly or indirectly via an intermediate buffer to the addressed resource. Optionally, the proxy core synchronizes and/or temporally decouples the data addressed to the resource from other processor cores to prevent interference or non-deterministic behavior.

If the case arises that multiple application cores want to simultaneously access a hardware resource managed by the proxy core, it does not result in a competing access that jeopardizes deterministic behavior. Rather, the proxy core, with the platform software running on it, will temporally decouple the multiple requests and forward them to the hardware resource managed by the proxy core in such a way that deterministic behavior is ensured. For example, a first access from one of the application cores is sent to and processed by the hardware resource before the second access is forwarded to the hardware resource. Thus, there is no simultaneous, competing access to the hardware resource.

According to an optional refinement of the present disclosure, it can further be provided that communication with a non-shared hardware resource (with respect to determinism requirements) takes place exclusively via a proxy core associated with that resource.

Exclusively assigning hardware resources to a managing proxy core is of course only done for those resources that cannot process simultaneous access by multiple application cores in a deterministic manner. If such hardware resources are identified, a proxy core is exclusively assigned to each of them; this proxy core handles the problem of simultaneous, competing access to that resource and guarantees deterministic behavior of the resource.

According to a refinement of the present disclosure, it can further be provided that the multicore processor is configured to statically assign exclusively to a processor core the hardware resources necessary for executing the platform software running on the at least one proxy core and/or the at least one application core, such as program and working memory, timers, configuration components, diagnostic components, and/or I/O ports, in order to ensure interference-free execution of the platform software on that processor core.

By statically assigning the components required to run the platform software to the at least one proxy core and/or the at least one application core, it is ensured that the platform software (on both the at least one proxy core and the at least one application core) runs without interference. After all, these components are available exclusively to the respective processor core so that it can execute the platform software without errors.

It is clear to the skilled person that, depending on complexity, one, two, or more proxy cores can be involved. The proposed architecture is configurable and expandable, and is adapted to the prevailing needs in each case. These needs can vary in particular (though not exclusively) with respect to the number and type of interfaces among the interfaces physically provided by the control component, the types of signals exchanged, the latency requirements, or the performance requirements of the application.

The disclosure also relates to a method for operating a multicore processor according to one of the aspects discussed above in an aircraft, optionally wherein the at least one application core and the at least one proxy core are each provided with a platform software that ensures that at least one resource that is actually accessible by more than two processor cores (or processor core types) is accessible only by exactly one proxy core, and wherein platform software that resolves competing accesses is provided if a deterministic behavior of the addressed resource is not guaranteed or evident in hardware when the processor cores access concurrently.

### BRIEF DESCRIPTION OF THE FIGURES

Further features, details and advantages of the disclosure will become apparent from the following description of the figures. In the figures:

FIG. 1: a schematic view of a multicore processor according to the disclosure, in which a first proxy core with the hardware resources allocated to it is highlighted graphically,

FIG. 2: a schematic view of a multicore processor according to the disclosure, in which a second proxy core with the hardware resources allocated to it is highlighted graphically,

FIG. 3: a schematic view of a multicore processor according to the disclosure, in which a first application core with the hardware resources allocated to it is highlighted graphically,

FIG. 4: a schematic view of a multicore processor according to the disclosure, in which a second application core with the hardware resources allocated to it is highlighted graphically,

FIG. 5: an illustration of the data output flow from the perspective of an application core, and

FIG. 6: an illustration of the data input flow from the perspective of an application core.

### DETAILED DESCRIPTION

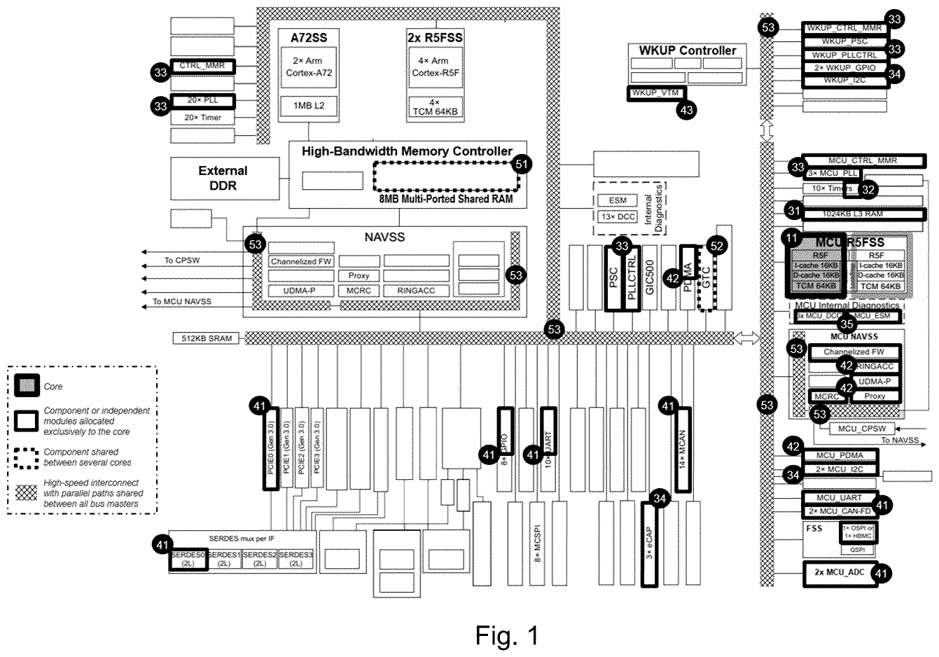

FIG. 1 shows a schematic illustration of a multicore processor from Texas Instruments™, namely the Jacinto™-7 (J7) type, by means of which the present disclosure is explained across FIGS. 1-4.

The first proxy core 11 is highlighted graphically along with the hardware components 31, 32, 33, 34, 35 that are exclusively assigned to it (and used only by proxy core 11), as well as the hardware components 41, 42, 43 to which the application cores have access via the first proxy core 11.

The hardware components 51, 52, 53, which can deterministically manage competing accesses within their bandwidth and are therefore jointly used by different proxy cores and application cores, are also highlighted graphically.

The depicted first proxy core 11 runs exclusively the platform software, but with different specifically assigned tasks. In FIG. 1, the first proxy core 11 is allocated on one core of the MCU_R5FSS dual-core cluster, and in the implementation shown here its tasks mainly involve management of digital and analog I/Os. The second core alongside proxy core 11 is deactivated according to the processor's mechanism.

To execute the platform software on proxy core 11, the proxy core 11 uses a program and working memory 31, a timer and interrupt controller 32, configuration components 33, peripheral components 34 (as I/O interfaces to external devices), as well as an engine 35 for diagnostics and for monitoring activities. These components are assigned exclusively to proxy core 11, so that only proxy core 11 can access these components for executing the platform software running on that core. These components can also be called exclusive components and are required for running the platform software.

Furthermore, there are hardware components 41, 42, 43 that proxy core 11 also accesses exclusively, but which are indirectly accessible to the application cores via proxy core 11. These hardware components can also be called managed components, because access to them is managed exclusively through proxy core 11. Other processor cores, apart from the proxy core assigned to the managed component, have no direct access, but can communicate with the hardware resource only indirectly through the proxy core.

The hardware components managed exclusively by proxy core 11, for which access by application cores is indirectly possible via proxy core 11, include, for example, peripheral components 41 as I/O interfaces to external devices, an internal engine/co-processor 42 (intended mainly for data transfer), as well as diagnostic-oriented components 43 for monitoring activities.

The further hardware components 51, 52, 53 are capable of deterministically managing competing accesses within their bandwidth and can therefore be commonly used by multiple proxy cores 11 and application cores. These components can also be referred to as shared components.

A shared component is, for example, a shared memory 51, which is used mainly for the exchange of data between at least one proxy core and at least one application core. In addition, there are shared synchronization components 52 for synchronizing the cores in use.

Reference sign 53 denotes an interconnect element as a concrete embodiment of a bus system, which enables communication between the different components of the multicore processor.

The serving role of each proxy core 11 is realized by components of the platform software 60 that are executed by the respective proxy core 11.

It can be provided that each proxy core 11, 12 is statically assigned, at design time, the necessary hardware resources that are not shared (such as program and working memory 31, timer 32, as well as configuration components 33, diagnostic components 35, and specific I/O ports 34) exclusively. This enables interference-free execution of the software running on cores 11, 12.

Hardware components 41, 42, 43 that cannot be used jointly in a deterministic manner by multiple processor cores but whose access by other processor cores is required or involved are statically assigned to a respective proxy core 11 by design.

Each proxy core takes over direct access for the hardware resources assigned to it, so that only this proxy core and no other cores can access them. If access from another core is required, it occurs by interposing the proxy core, which is in direct communication with the requested hardware component.

Furthermore, each proxy core is statically assigned—e.g., by design or via configuration file—at least one dedicated area of the shared memory 51, which is used for data exchange with the application cores.

It can also be provided that data originating from other processor cores, which is directed to a hardware component managed by the proxy core, are completed in format and protocol such that the data transfer between the application core and the managed hardware component is compatible.

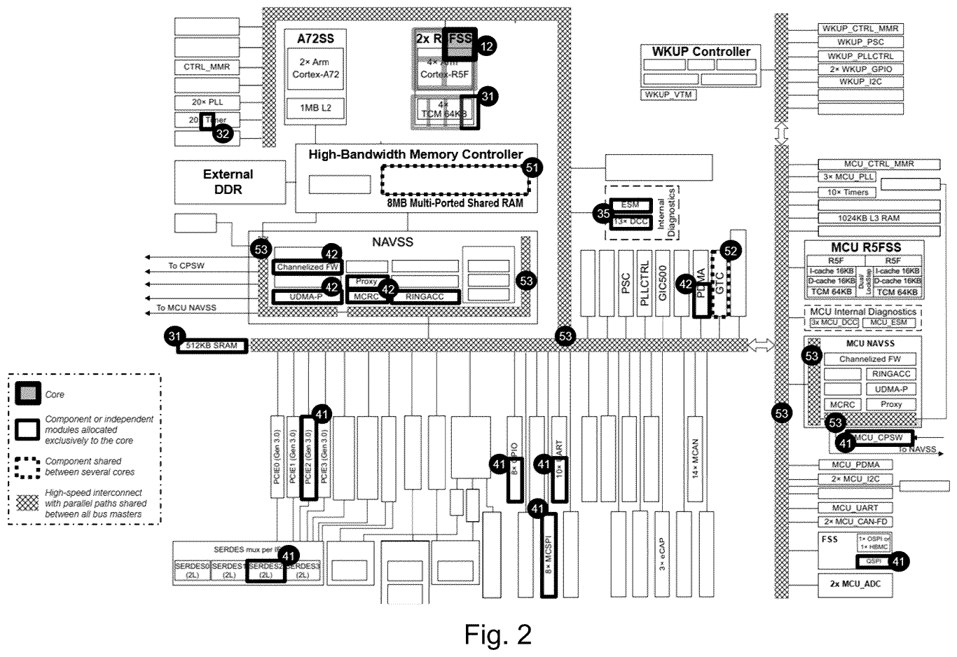

FIG. 2 shows a second proxy core 12 with the components of the multicore processor associated with it, which essentially correspond to those in FIG. 1, except that some components are implemented at different positions in the multicore processor.

For example, it can be seen that the second proxy core 12 is now a core of a quad-core architecture, whereas the first proxy core 11 is a core of a dual-core architecture.

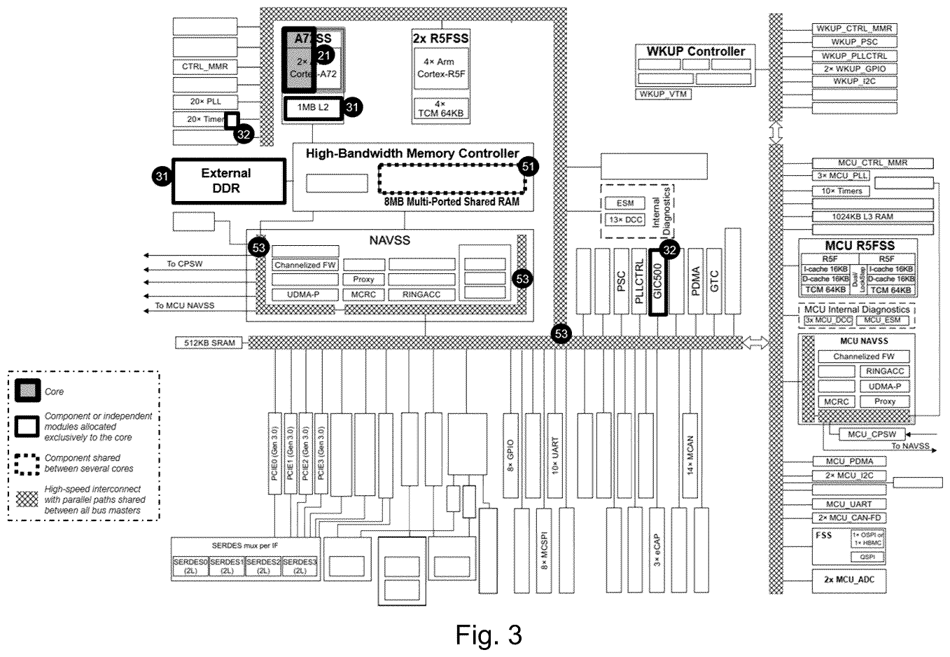

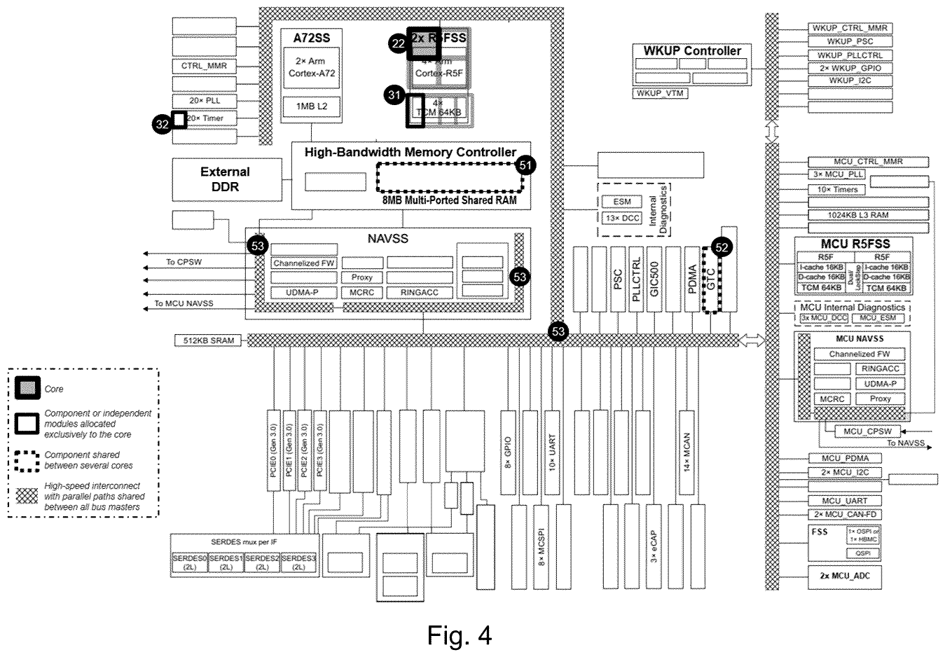

FIGS. 3 and 4 each show a schematic view of a multicore processor according to the disclosure, in which a respective application core is highlighted along with the hardware resources allocated to it.

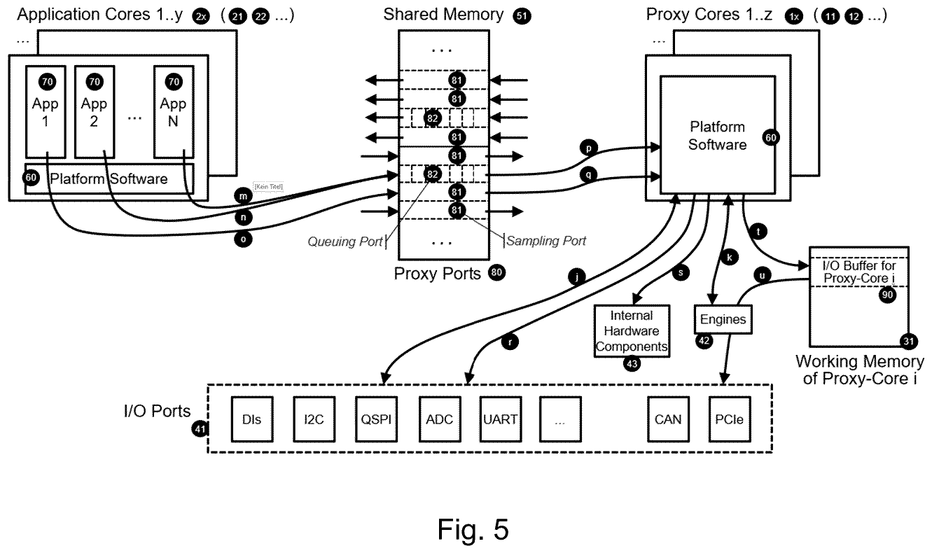

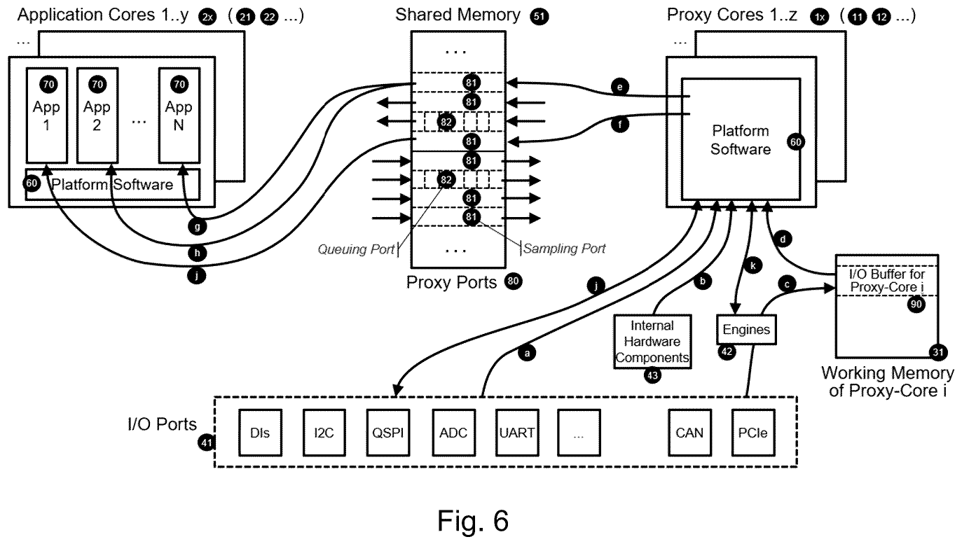

An application core 21, 22 is specialized in executing one or more software applications 70 (shown in FIG. 5 and FIG. 6). The software applications 70 can be user applications or platform-dedicated maintenance applications.

The software applications 70 have no direct access to the processor or the input and output interfaces (I/O ports), nor do they have direct access to the internal processor hardware resources 41, 42, 43 that require a specific access protocol for determinism. Direct accesses are performed by the platform software, PSW 60, running on the proxy cores as a service for the application cores 21, 22.

In the present example, the platform architecture is implemented with two application cores 21, 22 and the platform software 60. Depending on the complexity of the end product, one, two, or more application cores 21, 22 can be involved. The platform architecture is configurable and expandable, and is adapted to the needs of the end product in this sense, so that it is clear to the skilled person that the number of application cores, just like the number of proxy cores, is not limited to a specific amount.

Application cores 21, 22 execute specific components of PSW 60 to enable communication with proxy cores 11, 12.

Each application core 21, 22 is statically assigned by design the necessary hardware resources to be used only by that application core (such as program and working memory 31, and timer 32). This ensures interference-free execution of the software running on core 21, 22.

Additionally, each application core 21, 22 is statically assigned (by design or via configuration files) dedicated areas of the shared memory 51, which are used for data exchange with proxy cores 11, 12.

It is provided that an application core 21, 22 uses exclusively the hardware resources assigned to it.

Based on the illustrations in FIGS. 5 and 6, the implementation of the deterministic client-server communication between the application cores 21, 22 and the proxy cores 11, 12 is depicted.

This type of communication ensures that the accesses of the application cores 21, 22 to the I/O ports 41 and shared internal hardware components 42, 43 are carried out indirectly through the proxy cores 11, 12, so that no competing accesses occur which would undermine the intended determinism.

The principles of the platform architecture for the client-server communication implemented according to the disclosure are shown in FIG. 5 (for the data output flow) and FIG. 6 (for the data input flow).

Dedicated software components of PSW 60, designed for multiple bus masters competing for resources, implement the deterministic transfer of messages between resource-competing clients (for example, two different application cores 21, 22) and servers (the proxy cores 11, 12). This is accomplished via communication channels referred to as proxy ports. These are based on the combined use of at least one of the following features:

An implementation of a sampling and queuing ports concept, preferably supported by an implementation of the double-buffer technique and a dedicated management of the queue indices, to ensure real-time response and the integrity of messages during simultaneous read/write operations from multiple cores.

A specific mapping of the proxy ports onto the processor's most powerful internal memory component. This mapping exploits the high data transfer bandwidth and the multiple physical interfaces of the memory component. Thanks to these properties, competing accesses to the proxy ports can be performed in real time, provided these accesses remain within the bandwidth limits of the processor infrastructure.

A budget-based mechanism for the configurable limitation of the use of the proxy ports by the application cores, to avoid the risk of saturating the available bandwidth of the processor infrastructure between the cores and the memory.

The transfer of data from software applications 70 to output ports 41 or internal hardware components 43 (see FIG. 5) is implemented as outlined below:

The software applications 70 transmit application signals from different applications via respective virtual or physical data lines m, n, o to the corresponding proxy ports 80 by executing software components on the application cores 21, 22 and the platform software 60 running on them.

Each sampling port 81 and/or queuing port 82 is periodically and sequentially read and processed by the proxy cores 11, 12 along with the platform software 60 running on them, via corresponding data lines p, q. Any entry contained in a proxy port 80 is only transmitted (directly or indirectly) to the corresponding output port 41 or to the internal hardware resource 43 once that component is ready (e.g., when the previous transmission by the same component has finished).

Depending on the type of output ports 41, the transmission of the data to be sent is carried out by the proxy cores 11, 12 either directly (line j, r) to the output ports 41, or indirectly (line t, u) via output buffers 90 and internal data transfer engines 42. Each output buffer 90 resides in the working memory 31 of the corresponding proxy core 11, 12, which controls the assigned data transfer engines 42.

As needed, the internal data transfer engines 42 read the buffered data to be sent from an I/O buffer 90 in the working memory 31 of the respective proxy core and send it to the output port 41. Each internal data transfer engine 42 can be exclusively controlled by a single proxy core 11, 12 (via line k).

Depending on the type of application signal, multiple types of I/O ports 41 may be required for the same signal, among other things to ensure certain protocols with external devices. The platform software 60 of a proxy core 11, 12 takes over control of the required I/O ports to carry out the corresponding communication protocol (for example via line j).

The signals from the software application 70 are prepared and transmitted by the platform software 60 of proxy core 11, 12 in such a way that they are compatible with the format and protocols of the respective output ports 41 and any external devices or hardware components dependent on them.

The transfer of data from input ports 41 or internal hardware components 43 to one or more software applications 70 (cf. FIG. 6) is implemented as outlined below:

The data provided by the input ports 41 and/or internal hardware components 43 are delivered to the software applications 70 running on the application cores 21, 22 by transferring them via the platform software 60 running on the respective proxy core 11, 12 to the corresponding proxy ports 80 (cf. line e, f).

The data originating from the input ports 41 or internal hardware components 43 are read by the platform software 60 running on the respective proxy core 11, 12 either directly (via data line a, b) and/or indirectly (via data line c, d). The data can also be processed in terms of format and synchronization such that the processed signals can be directly utilized by a respective software application 70 on an application core 21, 22 after forwarding.

Depending on the type of input ports 41, the transmission of the provided data by the proxy cores 11, 12 can occur either directly from the input ports 41 or indirectly (via line c, d) through an input buffer 90 and/or an internal data transfer engine 42. Each input buffer 90 can reside in the working memory 31 of the proxy core 11, 12, which exclusively controls the at least one assigned data transfer engine 42.

The access of the software applications 70 to the proxy ports 80 can take place according to the configuration of their access rights.

The disclosure thus offers the possibility to certify multicore processors according to DO-178C and AMC 20-193. This is achieved because the present disclosure makes it possible to calculate the WCET (Worst-Case Execution Time) of each of the various software applications that are run on different cores of the processor. This is easier to compute thanks to the (potentially multiple) centralization of the shared use of resources. In comparison to solutions where access to resources is not coordinated among all consumers of the shared resources, the present disclosure enables a much more reliable calculation.

Furthermore, the present disclosure makes it possible to demonstrate the robust-partitioning property of the platform, which allows an incremental certification during multi-stage integration of new partitions corresponding to new product requirements.

A demonstration of data coupling between partitions can also be carried out much more easily, whereby the partitions exchange data but are not linked in the same binary code and are executed on different cores of the multicore processor.

In addition, the present disclosure makes it possible either to forgo an RTOS (real-time operating system) or to have a greater selection of RTOS, because the RTOS does not necessarily need built-in support for multicore processors—the control over potential interferences is taken over by the platform (extended AMP mode).

Lastly, the disclosure also enables optimized use of the application cores compared to single-or multiprocessor solutions, and to multicore solutions like “pure” AMP, SMP, and those with a hypervisor. This is because a division of labor takes place between proxy cores (for I/Os) and application cores, whereby more continuous processor time is available for executing the actual application. In single-or multiprocessor systems, by contrast, each processor must handle its own I/Os, which creates more overhead than a consolidated I/O processing on individual cores.

The implementation of the disclosure shown in FIGS. 1 to 4 consists of the inventive platform architecture for embedded systems, which is based on multicore processors of the Texas Instruments™ Jacinto™-7 type (DRA829, TDA4VM and similar derivatives). However, it is clear to the skilled person that the underlying idea of the present disclosure can of course also be applied to other multicore processors. According to the disclosure, specific structural and interface aspects are combined to enable a functional and temporal deterministic execution of software partitions for safety-critical (avionic) systems. This solution does not require a real-time operating system (RTOS) with special support for multicore processors.

Additionally, this architecture is based on a specific set of concepts for the efficient allocation of hardware resources to certain processor types (structural aspects) and a deterministic communication mechanism between the software applications that run on different cores of the multicore processor (interface aspects).

The individual or combined measures described above make it possible to isolate resources that in principle cannot be shared by multiple processor cores, and to use them jointly in a controlled and predictable way when needed. Together, these two measures eliminate non-quantifiable interference in the competing access of multiple processor cores to shared resources.

The disclosure enables centralized management of the shared resources without risking a non-deterministic response. It also allows the coexistence of multiple independent units for centralized resource management when required. Consequently, modularity is limited only by the number of cores and the bandwidth of the communication infrastructure of the multicore processor.

### REFERENCE NUMERALS LIST

### 1x Proxy Cores

11 first proxy core
12 second proxy core

### 2x Application Cores

21 first application core
22 second application core
   3x Hardware Components Exclusively Assigned to One Core, Used Only by that Core
31 program and working memory
32 timer and interrupt controller
33 configuration components
34 peripheral components as I/O interfaces to external components or devices
35 diagnostic-oriented engine/controller components for monitoring activities

### 4x Hardware Components Exclusively Assigned to One Proxy Core, Which Application Cores Access Indirectly Via the Proxy Core

41 peripheral components as I/O interfaces to external components or devices
42 internal engine/co-processor hardware components, mainly used for data transfer
43 diagnostic-oriented components for monitoring activities
   5x Infrastructure-Related Hardware Components That can Deterministically Manage Competing Accesses Within Their Bandwidth, and are Used Jointly by Multiple Proxy and/or Application Cores
51 shared memory, mainly used for exchanging data between the proxy cores and the application cores
52 shared component that is necessary for synchronizing the cores in use
53 interconnect (bus system) elements that enable communication between all master components and all slave components
60 platform software (PSW)
70 software application

1. A multicore processor, comprising:
at least one first processor core for performing computing operations, also called an application core; and
at least one second processor core for performing computing operations, also called a proxy core,
wherein the at least one application core and the at least one proxy core both have, from the perspective of the hardware architecture, access to processor and/or hardware resources,
wherein the at least one application core and the at least one proxy core are each provided with a platform software that is designed to ensure that the resources actually accessible by at least the two processor cores are accessible only by exactly one proxy core, and
wherein the platform software is provided if a deterministic behavior of the addressed resource is not guaranteed or evident in hardware when accessed concurrently by the processor cores.

2. The multicore processor according to claim 1, further comprising:
a memory that is configured for access by the at least one application core and the at least one proxy core,
at least one input/output interface and/or at least one internal hardware component for inputting or outputting data, which, based on a hardware architecture of the multicore processor, is accessible by the at least one application core and the at least one proxy core, and
a communication bus for connecting the at least one application core, the at least one proxy core, the memory, and the at least one input/output interface and/or the at least one internal hardware component,
wherein the at least one application core is configured, by virtue of the platform software, to refrain from direct access by the application core to the at least one input/output interface and/or the at least one internal hardware component and to route data directed thereto to the memory, and
wherein the at least one proxy core is configured, by virtue of the platform software, to pick up the data originating from the at least one application core from the memory and to forward it to the at least one input/output interface and/or the at least one internal hardware component.

3. The multicore processor according to claim 1, wherein the at least one application core and the at least one proxy core form heterogeneous processor cores with respect to each other.

4. The multicore processor according to claim 1, wherein the resource that is commonly usable from the perspective of the hardware architecture is used by only a single processor core, either the at least one application core or the at least one proxy core, if a competing access by more than one processor core does not guarantee a deterministic behavior or if such behavior is not verifiable.

5. The multicore processor according to claim 1, wherein the at least one application core and the at least one proxy core perform specific functions and tasks such that the assignment of the commonly usable resource, from the hardware perspective, is carried out so that each processor core can have either a common deterministic use or an exclusive use of the assigned resource.

6. The multicore processor according to claim 1, wherein access rights of processor cores for the resource commonly usable from the hardware architecture perspective, or even additional processor cores of the multicore processor itself, are deactivated if a resource that is shared across multiple processor cores cannot be used deterministically and cannot be exclusively assigned to one processor core.

7. The multicore processor according to claim 1, wherein a processor core to which a resource is exclusively assigned provides indirect access to certain resources to another or all other processor cores, while ensuring a deterministic access to these resources.

8. The multicore processor according to claim 1, further comprising an input/output interface and/or an internal hardware component, wherein:
the input/output interface comprises all types of binary signals, all types of static or dynamic signals from analog/digital and digital/analog converters, all types of signals from all types of communication controllers, whether requiring a specific protocol or not, and/or all types of signals from memory devices that require asynchronous management; and/or
the internal hardware component comprises passive components or active components.

9. The multicore processor according to claim 1, wherein at least one proxy core is provided which assumes the role of a server and is designed to execute at least partially the platform software that takes over direct access to now non-shared resources and implements the synchronization of accesses to these resources.

10. The multicore processor according to claim 1, wherein at least one application core is provided which is designed to execute at least one software application that only communicates indirectly with the now non-shared resources by sending or receiving data via the at least one proxy core to the desired resource.

11. The multicore processor according to claim 1, wherein the platform software provides a software-based mechanism for deterministic communication between the at least one application core and the at least one proxy core.

12. The multicore processor according to claim 1, wherein at least one proxy core is provided which is designed to receive data addressed to non-shared hardware resources from other processor cores, and to transfer these data directly or indirectly via an intermediate buffer to the addressed resource.

13. The multicore processor according to claim 1, wherein the multicore processor is designed such that communication with a non-shared hardware resource occurs exclusively via a proxy core associated with that resource.

14. The multicore processor according to claim 1, wherein the multicore processor is configured to statically assign exclusively to the processor core the hardware resources necessary for executing the platform software running on the at least one proxy core and/or the at least one application core such as program and working memory, timers, configuration components, diagnostic components, and/or I/O ports, in order to ensure interference-free execution of the platform software running on that processor core.

15. A method for operating the multicore processor according to claim 1 in an aircraft, wherein:
the at least one application core and the at least one proxy core are each provided with a platform software that ensures that the resources actually accessible by at least both processor cores are accessible only by exactly one proxy core, and
the platform software is provided if a deterministic behavior of the addressed resource is not guaranteed or evident in hardware when the processor cores access concurrently.

16. The multicore processor according to claim 1, wherein the access to processor and/or hardware resources comprises at least one input/output interface and/or at least one internal hardware component.

17. The multicore processor according to claim 2, wherein the memory is a shared memory.

18. The multicore processor according to claim 2, wherein static dedicated areas of the memory are assigned to the at least one proxy core and/or the at least one application core for data exchange between the processor cores.

19. The multicore processor according to claim 6, wherein the access rights of processor cores for the resource commonly usable from the hardware architecture perspective, or even additional processor cores of the multicore processor itself, are statically deactivated.

20. The multicore processor according to claim 8, wherein:
the passive components comprise slaves and the active components comprise bus masters; and
the slaves are registers of processor features, such as timers/counters, or configuration registers, or working memory for program instructions and program data; and/or
the bus masters are so-called engines that relieve a processor core from data transfer, complex calculations, or propagation of processor events.
